(19) United States
(12) Patent Application Publication
(10) Pub. No.: US 2026/0175735 A1
(43) Pub. Date: Jun. 25, 2026

(54) NETWORK ABNORMALITY RESPONSE SYSTEM OF ELECTRIC VEHICLE CHARGING DEVICE

(71) Applicant: SK Signet Inc., Yeonggwang-gun (KR)

(72) Inventor: Young Chan Kim, Seoul (KR)

(21) Appl. No.: 19/431,818

(22) Filed: Dec. 23, 2025

(30) Foreign Application Priority Data
Dec. 24, 2024 (KR) 10-2024-0194850

(51) Int. Cl. B60L 53/68; B60L 53/30; B60L 53/66; G06Q 30/0207

(52) U.S. Cl. CPC B60L 53/68; B60L 53/305; B60L 53/66; G06Q 30/0207

(57) ABSTRACT

A network abnormality response system may include: a modem included in each of dispensers for charging an electric vehicle; and a processor controlling the dispenser to perform communication through a bypass route when a communication error situation occurs between a modem of the dispenser and a central server, wherein the processor may: determine whether the modem of the dispenser is an error-occurring modem of an error-occurring dispenser in which a communication error has occurred between the modem and the central server; and control a normal modem to transmit or receive information to be transmitted to or received from the central server by the error-occurring dispenser to or from the central server through the normal modem when the error-occurring modem is present, and the normal modem may be a modem included in a normal dispenser that is not the error-occurring dispenser and/or a vehicle modem included in an electric vehicle.

### CROSS-REFERENCE TO RELATED PATENT APPLICATION

This application claims the benefit of Korean Patent Application No. 10-2024-0194850, filed on Dec. 24, 2024, in the Korean Intellectual Property Office, the disclosure of which is incorporated herein in its entirety by reference.

### TECHNICAL FIELD

The present disclosure relates to a network abnormality response system that may respond to a failure situation of a modem provided in an electric vehicle charging device.

### BACKGROUND

A user connects a connector and a charging cable of a dispenser to an electric vehicle at an electric vehicle charging station in order to charge the vehicle and proceeds through a procedure for starting charging.

A modem is usually included in the dispenser of an electric vehicle charging device. Since the dispenser is not merely a device that supplies electric power, but should perform charging management and communication functions, the modem or another communication device is necessarily embedded therein. In particular, the modem plays a critical role in a smart charging station environment where network communication is necessary.

### SUMMARY

### Technical Problem

The present disclosure is directed to providing a network abnormality response system that may transmit or receive data to be transmitted to or received by a corresponding dispenser to or from a server even when a modem of any one dispenser is unable to communicate with the server.

In addition, the present disclosure is directed to providing a network abnormality response system that may maintain communication by using a modem of an adjacent charging device when a modem failure occurs in any charging device by connecting the modems of the charging device equipped with the modem with one another through a local area network (LAN) or a wide area network (WAN).

In addition, the present disclosure is directed to providing a network abnormality response system in which a vehicle equipped with a modem capable of communication may serve as the modem itself, thereby enabling communication for a corresponding charging device when the vehicle is connected to a charging device that is unable to communicate.

In addition, the present disclosure is directed to providing a network abnormality response system in which a vehicle equipped with a modem stores information regarding a charging device in which an error has occurred or that is in a failure state and then transmits the information to another charging device or another electric mobility while the vehicle moves, thereby transmitting the information to a charging device manufacturer or a charging device maintenance company, etc.

In addition, the present disclosure is directed to providing a network abnormality response system that may provide a discount of a charging fee to a vehicle that contributes to transmitting failure information.

In addition, the present disclosure is directed to providing a network abnormality response system that may guide a driver of a vehicle to contribute to transmitting failure information.

In addition, the present disclosure is directed to providing a network abnormality response system that may improve performance such as an increase in data processing speed or a decrease in required memory capacity compared to a conventional system.

### Technical Solution

A network abnormality response system according to an aspect of the present disclosure may include at least one modem included in each of a plurality of dispensers for charging an electric vehicle, and a processor that controls the dispenser to perform communication through a bypass route when a communication error situation occurs between a modem of the dispenser and a central server, wherein the processor may: determine whether the at least one modem of the dispenser is an error-occurring modem of an error-occurring dispenser in which a communication error has occurred between the modem and the central server; and control a normal modem to transmit or receive information to be transmitted to or received from the central server by the error-occurring dispenser to or from the central server through the normal modem when the error-occurring modem is present, and the normal modem may be at least one of a modem included in a normal dispenser that is not the error-occurring dispenser and a vehicle modem included in an electric vehicle.

In addition, the processor may control at least one of a first normal modem and a second normal modem to transmit information to be transmitted to the central server by the error-occurring dispenser to the central server through at least one of the first normal modem and the second normal modem when the error-occurring modem is present, wherein the first normal modem may be at least one of a normal modem electrically connected to the error-occurring modem so as to enable wired communication therebetween and the vehicle modem electrically connected to the error-occurring dispenser and included in the electric vehicle, and the second normal modem may be a modem included in the electrically connected normal dispenser after the electric vehicle that is electrically connected to the error-occurring dispenser is electrically connected to the error-occurring dispenser.

In addition, the modem provided for each dispenser included in one electric vehicle charging station may be electrically connected to modems of other dispensers so as to enable wired communication therebetween, and the processor may control the first normal modem to transmit or receive the information to be transmitted to or received from the central server by the error-occurring dispenser to or from the central server through the first normal modem that is electrically connected to the error-occurring modem in the electric vehicle charging station when the error-occurring modem is present.

In addition, the processor may determine whether the first normal modem that is electrically connected to the error-occurring modem in the electric vehicle charging station is present when the error-occurring modem is present, and may control the second normal modem to transmit the information to be transmitted to the central server by the error-occurring dispenser to the central server through the second normal modem when all modems respectively provided in the dispensers included in the electric vehicle charging station in which the error-occurring dispenser is provided are the error-occurring modem.

In addition, the processor may determine whether communication between the error-occurring modem and the first normal modem is possible in the electric vehicle charging station when the error-occurring modem is present, and may control the second normal modem to transmit the information to be transmitted to the central server by the error-occurring dispenser to the central server through the second normal modem when a communication error has occurred between the error-occurring modem and the first normal modem.

In addition, the processor may: store charging device error information including at least one of ID information, position information, and error type information of the error-occurring dispenser in a vehicle memory of the electric vehicle connected to the error-occurring dispenser; and control the second normal modem so as to transmit the charging device error information stored in the vehicle memory to the central server when the electric vehicle is electrically connected to the normal dispenser.

In addition, the processor may: control a display included in the error-occurring dispenser; and control the display so as to display a repair-assistance request screen when the electric vehicle is electrically connected to the error-occurring dispenser, wherein the repair-assistance request screen may be a screen requesting a driver of the electric vehicle to contribute to transmitting the charging device error information to the central server by connecting the electric vehicle to another dispenser.

In addition, the processor may control the display so as to display a discounted-price proposal screen when the electric vehicle is electrically connected to the error-occurring dispenser, and the discounted-price proposal screen may be a screen proposing to the driver of the electric vehicle that when the driver connects the electric vehicle to another dispenser and thereby contributes in transmitting the charging device error information to the central server, a charging fee will be discounted relative to a standard charging fee.

In addition, when the second normal modem transmits the charging device error information stored in the vehicle memory to the central server, the processor may determine a discounted charging fee that is discounted relative to a standard charging fee corresponding to a charging process of the electric vehicle connected to the normal dispenser, and may control the normal dispenser to perform a billing process that bills the discounted charging fee to the electric vehicle.

In addition, when the second normal modem transmits the charging device error information stored in the vehicle memory to the central server, the processor may: determine an information storage time that is a time taken from a time point at which the vehicle memory of the electric vehicle stored the charging device error information to a time point at which the second normal modem transmits the charging device error information stored in the vehicle memory to the central server; and determine the discounted charging fee so that the longer the information storage time is, the less a discounted charging fee corresponding to the charging process is billed.

A method of controlling a network abnormality response system according to an aspect of the present disclosure, including at least one modem included in each of a plurality of dispensers for charging an electric vehicle and a processor may include performing, by the processor, communication through a bypass route when a communication error situation occurs between a modem of the dispenser and a central server, wherein the performing of the communication through the bypass route may include: determining, by the processor, whether at least one modem of the dispenser is an error-occurring modem of an error-occurring dispenser in which a communication error has occurred between the modem and the central server; and controlling, by the processor, the normal modem to transmit or receive information to be transmitted to or received from the central server by the error-occurring dispenser to or from the central server through the normal modem when the error-occurring modem is present, wherein the normal modem may be at least one of a modem included in a normal dispenser that is not the error-occurring dispenser and a vehicle modem included in an electric vehicle.

In addition, the controlling of the normal modem may include controlling, by the processor, at least one of a first normal modem and a second normal modem to transmit the information to be transmitted to the central server by the error-occurring dispenser to the central server through at least one of the first normal modem and the second normal modem when the error-occurring modem is present, wherein the first normal modem may be at least one of a normal modem electrically connected to the error-occurring modem so as to enable wired communication therebetween and the vehicle modem electrically connected to the error-occurring dispenser and included in the electric vehicle, and the second normal modem may be a modem included in the electrically connected normal dispenser after the electric vehicle that is electrically connected to the error-occurring dispenser is electrically connected to the error-occurring dispenser.

In addition, the modem provided for each dispenser included in one electric vehicle charging station may be electrically connected to modems of other dispensers so as to enable wired communication therebetween, and the controlling of the normal modem may include controlling, by the processor, the first normal modem to transmit or receive the information to be transmitted to or received from the central server by the error-occurring dispenser to or from the central server through the first normal modem that is electrically connected to the error-occurring modem in the electric vehicle charging station when the error-occurring modem is present.

In addition, the controlling of the normal modem may include: determining, by the processor, whether the first normal modem that is electrically connected to the error-occurring modem in the electric vehicle charging station is present when the error-occurring modem is present; and controlling, by the processor, the second normal modem to transmit the information to be transmitted to the central server by the error-occurring dispenser to the central server through the second normal modem when all modems respectively provided in the dispensers included in the electric vehicle charging station in which the error-occurring dispenser is provided are the error-occurring modem.

In addition, the controlling of the normal modem may include: determining, by the processor, whether communication between the error-occurring modem and the first normal modem is possible in the electric vehicle charging station when the error-occurring modem is present; and controlling, by the processor, the second normal modem to transmit the information to be transmitted to the central server by the error-occurring dispenser to the central server through the second normal modem when a communication error has occurred between the error-occurring modem and the first normal modem.

In addition, the controlling of the normal modem may include: storing, by the processor, charging device error information including at least one of ID information, position information and error type information of the error-occurring dispenser in a vehicle memory of the electric vehicle connected to the error-occurring dispenser; and controlling, by the processor, the second normal modem so as to transmit the charging device error information stored in the vehicle memory to the central server when the electric vehicle is electrically connected to the normal dispenser.

In addition, the method may further include controlling, by the processor, a display included in the error-occurring dispenser, wherein the controlling of the display may include controlling, by the processor, the display so as to display a repair-assistance request screen when the electric vehicle is electrically connected to the error-occurring dispenser, wherein the repair-assistance request screen may be a screen requesting a driver of the electric vehicle to contribute to transmitting the charging device error information to the central server by connecting the electric vehicle to another dispenser.

In addition, the controlling of the display may include controlling, by the processor, the display so as to display a discounted-price proposal screen when the electric vehicle is electrically connected to the error-occurring dispenser, and the discounted-price proposal screen may be a screen proposing to the driver of the electric vehicle that when the driver connects the electric vehicle to another dispenser and thereby contributes in transmitting the charging device error information to the central server, a charging fee will be discounted relative to a standard charging fee.

In addition, the method may further include, when the second normal modem transmits the charging device error information stored in the vehicle memory to the central server, determining, by the processor, a discounted charging fee that is discounted relative to a standard charging fee corresponding to a charging process of the electric vehicle connected to the normal dispenser, and controlling, by the processor, the normal dispenser to perform a billing process that bills the discounted charging fee to the electric vehicle, wherein the determining the discounted charging fee may include: determining, by the processor, an information storage time that is a time taken from a time point at which the vehicle memory of the electric vehicle stored the charging device error information to a time point at which the second normal modem transmits the charging device error information stored in the vehicle memory to the central server, and determining, by the processor, the discounted charging fee so that the longer the information storage time is, the less a discounted charging fee corresponding to the charging process is billed.

A computer program according to an aspect of the present disclosure may be stored in a non-transitory computer-readable recording medium so as to execute the method of controlling the network abnormality response system.

### Advantageous Effects

According to an aspect of the disclosure, it is possible to transmit and receive data to be transmitted and received by a corresponding dispenser to and from a server even when a modem of any one dispenser is unable to communicate with the server.

According to another aspect of the disclosure, it is possible to maintain communication by using a modem of an adjacent charging device when a modem failure occurs in any charging device by connecting the modems of the charging device equipped with the modem with one another through a local area network (LAN) or a wide area network (WAN).

According to another aspect of the disclosure, a vehicle equipped with a modem capable of communication can serve as a modem itself, thereby enabling communication for a corresponding charging device when the vehicle is connected to a charging device that is unable to communicate.

According to another aspect of the disclosure, a vehicle equipped with a modem stores information regarding a charging device in which an error has occurred or that is in a failure state and then transmits the information to another charging device or another electric mobility while the vehicle moves, thereby transmitting the information to a charging device manufacturer or a charging device maintenance company, etc.

According to another aspect of the disclosure, a discount of a charging fee can be provided to a vehicle that contributes to transmitting failure information.

According to another aspect of the disclosure, a driver of a vehicle can be guided to contribute to transmitting failure information.

According to another aspect of the disclosure, performance such as an increase in data processing speed or a decrease in required memory capacity can be improved compared to a conventional system.

### BRIEF DESCRIPTION OF THE DRAWINGS

FIG. 1 is a control block diagram of a network abnormality response system according to an embodiment.

FIG. 2 is a view showing a configuration of an electric vehicle charging station controlled by a network abnormality response system according to an embodiment.

FIG. 3 is a view for describing a problem of a conventional communication method.

FIG. 4 is a view for describing communication through a bypass route using a plurality of dispensers according to an embodiment.

FIG. 5 is a view for describing a method of transmitting charging device error information according to an embodiment.

FIG. 6 is a flowchart of a method of controlling a network abnormality response system according to an embodiment.

### DETAILED DESCRIPTION OF THE EMBODIMENTS

Same reference numerals refer to same components throughout the specification. This specification does not describe all elements of the embodiments, and contents that are general in the technical field to which the disclosed invention belongs or that overlap between the embodiments are omitted.

As used herein, the term “module” refers to a unit that processes at least one function or operation and may refer to, for example, software, a field-programmable gate array (FPGA), or a hardware component. The functions provided in the “module” may be performed separately by a plurality of components or may be integrated with other additional components. The “module” in this specification is not necessarily limited to software or hardware, and may be configured to reside on an addressable storage medium, and may be configured to boot one or more processors.

When a part of a specification is “connected” to another part, this includes not only a case of a direct connection, but also a case of an indirect connection in which still another part is present between the part and the another part.

In addition, when a part is said to “include” a component, this does not mean that it excludes other components, but rather that it may include other components, unless otherwise specifically described.

The terms “first”, “second”, etc. are used to distinguish one component from another, and the components are not limited by the aforementioned terms.

Singular expressions include plural expressions unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, an operation principle and embodiments of the disclosed invention will be described in detail with reference to accompanying drawings.

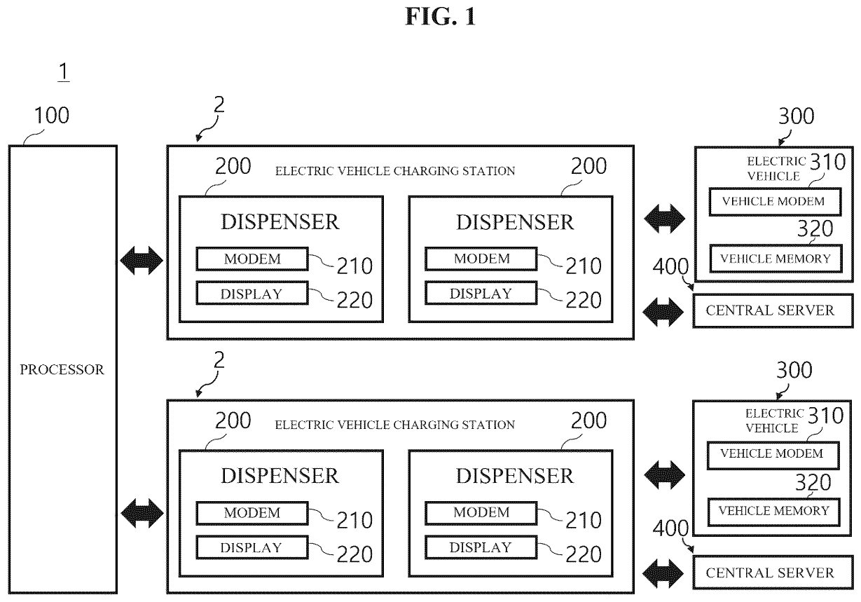

FIG. 1 is a control block diagram of a network abnormality response system according to an embodiment.

Referring to FIG. 1, a network abnormality response system 1 may be a system that is provided at a charging station that charges an electric vehicle 300 or on a server so as to communicate with the charging station and may be a system that may control a dispenser 200 of the charging station.

When a connector provided in the dispenser 200 for charging an electric vehicle is mounted to an electric vehicle 300, electric power may be supplied from the dispenser 200 to the electric vehicle 300 through a charging line provided inside a cable connected to the corresponding connector. In this case, the dispenser 200 may not only supply power to the electric vehicle 300, but may also perform communication of transmitting or receiving data to or from the electric vehicle 300 through a wired connection.

The network abnormality response system 1 may include at least one modem 210 and a processor 100.

In addition, the network abnormality response system 1 may include or control components provided in the dispenser 200. Specifically, the network abnormality response system 1 may include or control a connector, a cable, a cooling pipe, a fan, a refrigerant tank, a display 220, and a communication module provided in the dispenser 200.

The network abnormality response system 1 may be a server of a charging station capable of wired or wireless communication with a plurality of the dispensers 200 for a plurality of the charging stations, but the network abnormality response system 1 is not necessarily limited to being provided in a server. For example, each component of the network abnormality response system 1 may be provided in each dispenser 200. That is, the processor 100 may each be provided in any one of the server capable of communication with the dispenser 200 or the dispenser 200, or may be provided in both the server or the dispenser 200 as a plurality of the components.

The connector may be provided in the dispenser 200 and may be configured in a shape corresponding to a charging port of the electric vehicle 300. When the connector is mounted to the charging port of the electric vehicle 300, electric charging for the electric vehicle 300 may start under control of the dispenser 200.

One end of the cable may be connected to the connector. The connector may be equipped with the charging line and the cooling pipe through which refrigerant flows. The charging line may be a charging line configured to provide power to the electric vehicle 300 connected to the connector. Although the cable is provided as a single cable in the dispenser 200, a plurality of cables may be provided.

At least one modem 210 may be included in each of the plurality of dispensers 200 for charging the electric vehicle.

The processor 100 may control the dispenser 200 to perform communication through a bypass route when a communication error situation occurs between the modem 210 of the dispenser 200 and the central server 400.

The processor 100 may determine whether at least one modem 210 of the dispenser 200 is an error-occurring modem 213. The error-occurring modem 213 may be a modem 210 of an error-occurring dispenser 202. The error-occurring dispenser 202 may be a dispenser 200 in which a communication error has occurred between the modem and the central server 400.

When the error-occurring modem 213 is present, the processor 100 may control the normal modem to transmit or receive information to be transmitted to or received from the central server 400 by the error-occurring dispenser 202 to or from the central server 400 through the normal modem.

The normal modem may be at least one of a modem 210 included in a normal dispenser 201 and a vehicle modem 310 and may be a modem capable of normally communicating with the central server 400.

A normal dispenser 201 is a dispenser 200 that is not the error-occurring dispenser 202 and may be a dispenser 200 capable of normally communicating with the central server 400.

The vehicle modem 310 may be a modem included in the electric vehicle 300 and may be a modem that performs communication between various electric devices of the electric vehicle 300 and the central server 400.

When the error-occurring modem 213 is present, the processor 100 may control at least one of a first normal modem 211 and a second normal modem 212 to transmit information to be transmitted to the central server 400 by the error-occurring dispenser 202 to the central server 400 through at least one of the first normal modem 211 and the second normal modem 212.

The first normal modem 211 may be a normal modem that is at least one of the normal modem and the vehicle modem 310.

The normal modem may be a modem 210 electrically connected to the error-occurring modem 213 so as to enable wired communication therebetween.

The vehicle modem 310 may be a modem included in the electric vehicle 300 that is electrically connected to the error-occurring dispenser 202.

The second normal modem 212 may be a normal modem included in the electrically connected normal dispenser 201 after the electric vehicle 300 that is electrically connected to the error-occurring dispenser 202 is electrically connected to the error-occurring dispenser 202.

The second normal modem 212 may be a normal modem of a normal dispenser 201 provided in the same electric vehicle charging station 2 as the error-occurring dispenser 202 to which the electric vehicle 300 has been connected, or may be a normal modem of a normal dispenser 201 provided in a different electric vehicle charging station 2.

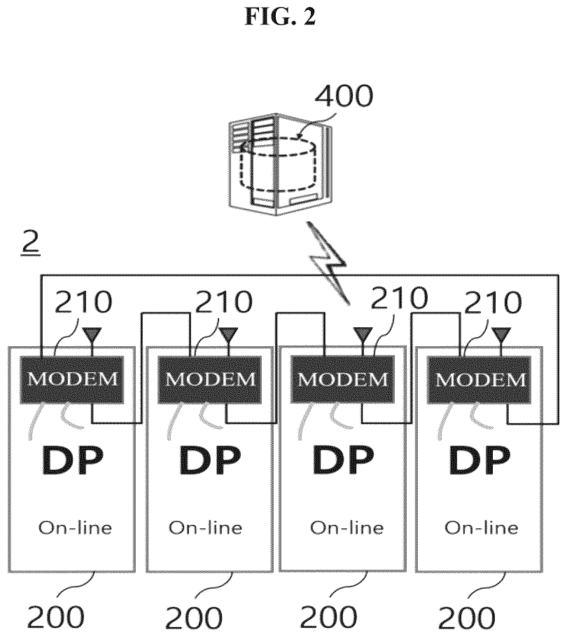

FIG. 2 is a view showing a configuration of an electric vehicle charging station controlled by a network abnormality response system according to an embodiment.

Referring to FIG. 2, the modem 210 provided for each dispenser 200 included in a single electric vehicle charging station 2 may be electrically connected so as to enable wired communication with the modems 210 of other dispensers 200.

In this case, the modems 210 of respective dispensers 200 may be connected to each other by a local area network (LAN) cable that is a physical medium for wired communication, but it is not limited thereto. A LAN cable is an Ethernet cable and may be a physical medium for transmitting data over a wired network. The LAN cable is used in a local area network (LAN) and enables data communication by connecting a computer, a router, a switch, a modem 210, etc. This is wired communication, and thus data transfer rate is high and signal interference is less than wireless communication.

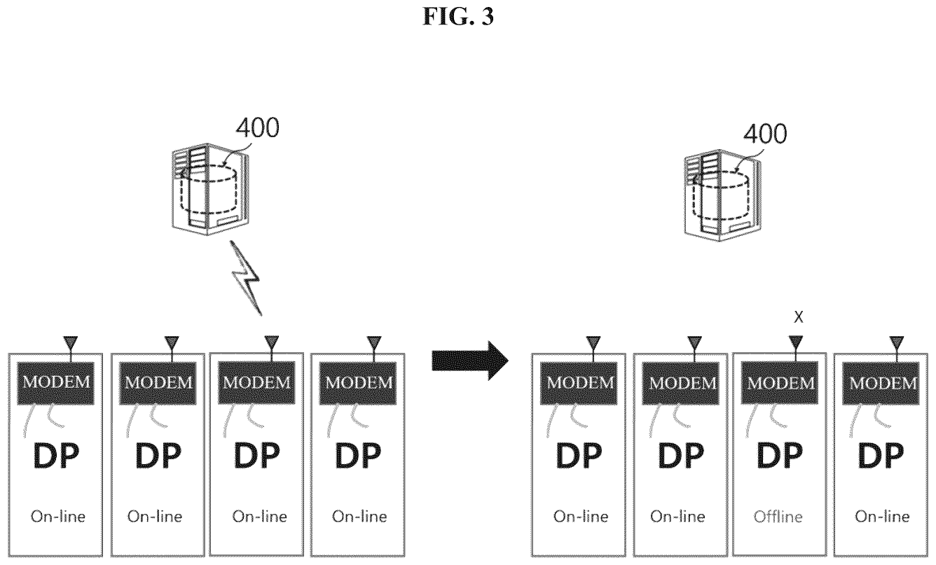

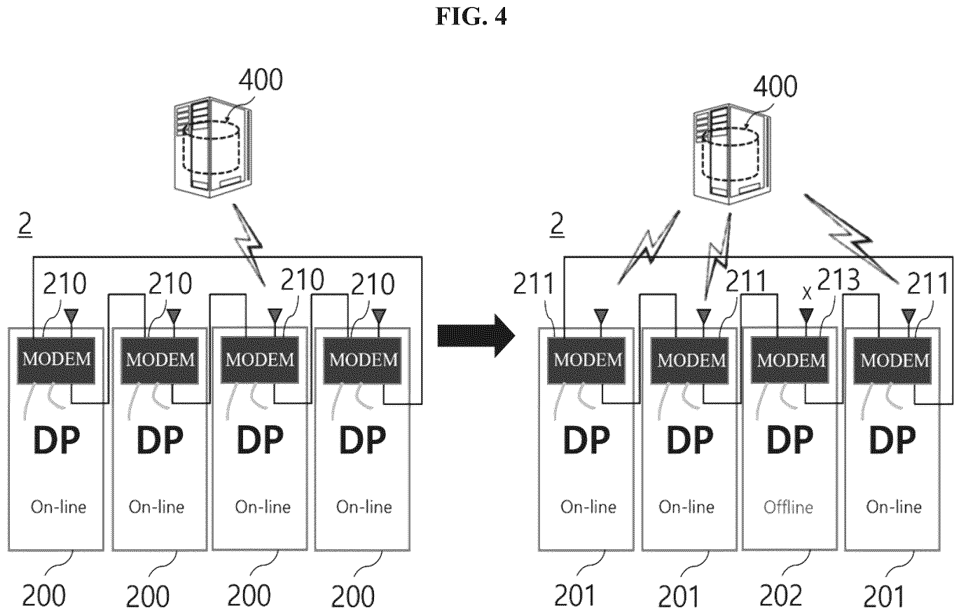

FIG. 3 is a view for describing a problem of a conventional communication method, and FIG. 4 is a view for describing communication through a bypass route using a plurality of dispensers according to an embodiment.

Referring to FIG. 3, when any one modem becomes unable to communicate with the central server 400 and becomes an error-occurring modem, a dispenser in which the corresponding error-occurring modem is provided becomes an error-occurring dispenser so that communication with the central server 400 is impossible and charging an electric vehicle using the corresponding dispenser may become impossible.

Accordingly, even when it is necessary to repair the corresponding modem later, there is a problem that the dispenser including the corresponding modem may not be used for electric vehicle charging at all until the corresponding modem is repaired.

Referring to FIG. 1, FIG. 2 and FIG. 4, when the error-occurring modem 213 is present, the processor 100 may control the first normal modem 211 to transmit or receive information to be transmitted to or received from the central server 400 by the error-occurring dispenser 202 to or from the central server 400 through the first normal modem 211 that is electrically connected to the error-occurring modem 213 in the electric vehicle charging station 2.

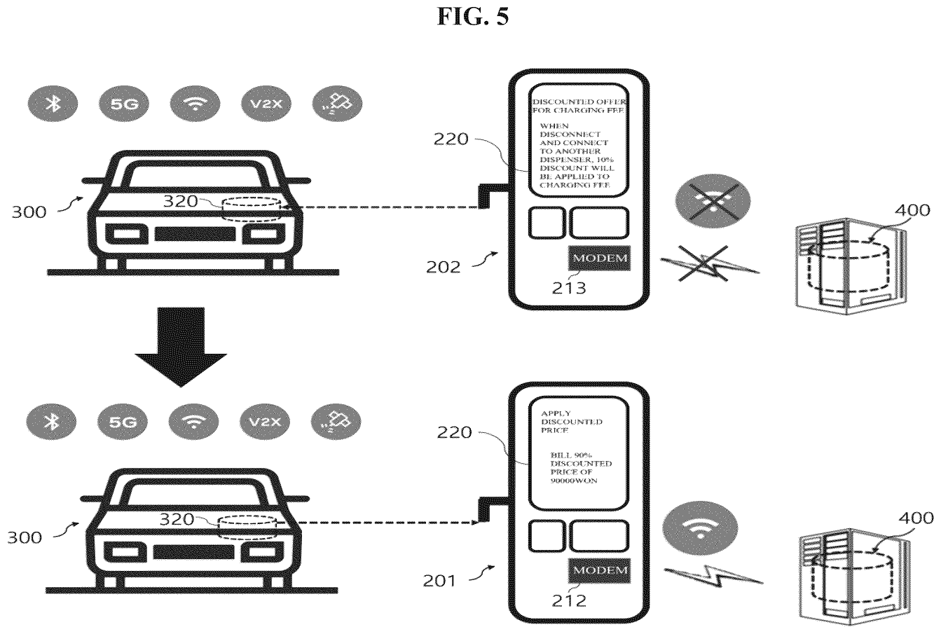

FIG. 5 is a view for describing a method of transmitting charging device error information according to an embodiment.

Referring to FIG. 1 and FIG. 5, when the error-occurring modem 213 is present, the processor 100 may determine whether the first normal modem 211 that is electrically connected to the error-occurring modem 213 is present in the electric vehicle charging station 2.

When all modems 210 respectively provided in the dispensers 200 included in the electric vehicle charging station 2 in which the error-occurring dispenser 202 is provided are the error-occurring modem 213, the processor 100 may control the second normal modem 212 to transmit information to be transmitted to the central server 400 by the error-occurring dispenser 202 to the central server 400.

As such, when all dispensers 200 of any one electric vehicle charging station 2 are the error-occurring dispenser 202, the network abnormality response system 1 may transmit information to be transmitted to the central server 400 by the error-occurring dispenser 202 to the central server 400 through the second normal modem 212 provided in another electric vehicle charging station 2.

When the error-occurring modem 213 is present, the processor 100 may determine whether communication between the error-occurring modem 213 and the first normal modem 211 in the electric vehicle charging station 2 is possible.

When a communication error has occurred between the error-occurring modem 213 and the first normal modem 211, the processor 100 may control the second normal modem 212 to transmit information to be transmitted to the central server 400 by the error-occurring dispenser 202 to the central server 400 through the second normal modem 212.

As such, when communication between the error-occurring dispenser 202 and other dispensers 200 of the electric vehicle charging station 2 is impossible, the network abnormality response system 1 may transmit information to be transmitted to the central server 400 by the error-occurring dispenser 202 to the central server 400 through the second normal modem 212 provided in another electric vehicle charging station 2.

Meanwhile, when the error-occurring dispenser 202 is present, it is preferable that a manager of the dispenser 200 may repair it by promptly transmitting information of the corresponding error-occurring dispenser 202 to the central server 400 rather than simply transmitting and receiving data to be transmitted or received by the error-occurring dispenser 202 to or from the central server 400.

The processor 100 may store charging device error information in a vehicle memory 320 of the electric vehicle 300 connected to the error-occurring dispenser 202.

The charging device error information may include at least one of ID information, position information, and error type information regarding the error-occurring dispenser 202.

The ID information is information regarding a unique ID of the error-occurring dispenser 202, the position information is information regarding a position of the electric vehicle charging station 2 in which the error-occurring dispenser 202 is positioned, and the error type information is information regarding a failure type of the error-occurring dispenser 202 and may include information indicating that the modem 210 has failed.

When the electric vehicle 300 is electrically connected to the normal dispenser 201, the processor 100 may control the second normal modem 212 of the normal dispenser 201 to which the electric vehicle 300 is connected to transmit the charging device error information stored in the vehicle memory 320 to the central server 400.

Meanwhile, the network abnormality response system 1 may guide a driver of the electric vehicle to contribute to transmitting the failure information.

The processor 100 may control a display 220 included in the error-occurring dispenser 202. When the electric vehicle 300 is electrically connected to the error-occurring dispenser 202, the processor 100 may control the display 220 to display a repair-assistance request screen.

The repair-assistance request screen may be a screen requesting the driver of the electric vehicle 300 to contribute to transmitting the charging device error information to the central server 400 by connecting the electric vehicle 300 to another dispenser 200.

When the electric vehicle 300 is electrically connected to the error-occurring dispenser 202, the processor 100 may control the display 220 to display a discounted-price proposal screen.

The discounted-price proposal screen may be a screen proposing that when the driver of the electric vehicle 300 contributes to transmitting the charging device error information to the central server 400 by connecting the electric vehicle 300 to another dispenser 200, a charging fee will be discounted relative to a standard charging fee. The repair-assistance request screen and the discounted-price proposal screen may be the same screen.

For example, when the electric vehicle 300 is electrically connected to the error-occurring dispenser 202, the processor 100 may control the display 220 so as to display the repair-assistance request screen and the discounted-price proposal screen in which a phrase such as “Discount offer for charging fee, when you disconnect and connect to another dispenser, 10% discount will be applied to the charging fee” is displayed.

When the second normal modem 212 transmits the charging device error information stored in the vehicle memory 320 to the central server 400, the processor 100 may determine a discounted charging fee that is a discounted relative to a standard charging fee corresponding to a charging process for the electric vehicle 300 connected to the normal dispenser 201.

For example, according to a normal charging process for the electric vehicle 300, when a price corresponding to an amount of power charged by the electric vehicle 300 is 100,000 won, the processor 100 may determine 90,000 won as the discounted charging fee that is discounted by a predetermined 10% relative to the standard charging fee for the electric vehicle 300 that contributed to transmitting the charging device error information to the central server 400.

The processor 100 may control the normal dispenser 201 to perform a billing process that bills the discounted charging fee to the electric vehicle 300.

Meanwhile, it may be reasonable to set a degree of discount differently depending on a case. For example, storing the charging device error information in the vehicle memory 320 of the electric vehicle 300 is temporarily renting someone else's memory capacity, and thus it may be reasonable that the longer the charging device error information is stored, the greater the discount becomes.

When the second normal modem 212 transmits the charging device error information stored in the vehicle memory 320 to the central server 400, the processor 100 may determine an information storage time.

The information storage time may be a time taken from a time point at which the vehicle memory 320 of the electric vehicle 300 stored the charging device error information to a time point at which the second normal modem 212 transmits the charging device error information stored in the vehicle memory 320 to the central server 400.

The processor 100 may determine the discounted charging fee so that the longer the information storage time is, the less a discounted charging fee corresponding to the charging process is billed.

For example, the processor 100 may determine an amount discounted by 5% relative to the standard charging fee as the discounted charging fee when the information storage time is two hours, and may determine an amount discounted by 10% relative to the standard charging fee as the discounted charging fee when the information storage time is four hours.

Meanwhile, a criterion for varying a degree of discount is not limited to the above-mentioned manner, and rather, the shorter the information storage time becomes, the faster the transmission of the charging device error information becomes, and thus the discounted charging fee may be determined so that the shorter the information storage time becomes, the less the discounted charging fee is billed, thereby guiding the driver of the electric vehicle 300 to provide prompt cooperation.

For example, conversely in this case, the processor 100 may determine an amount discounted by 10% relative to the standard charging fee as the discounted charging fee when the information storage time is two hours, and may determine an amount discounted by 5% relative to the standard charging fee as the discounted charging fee when the information storage time is four hours.

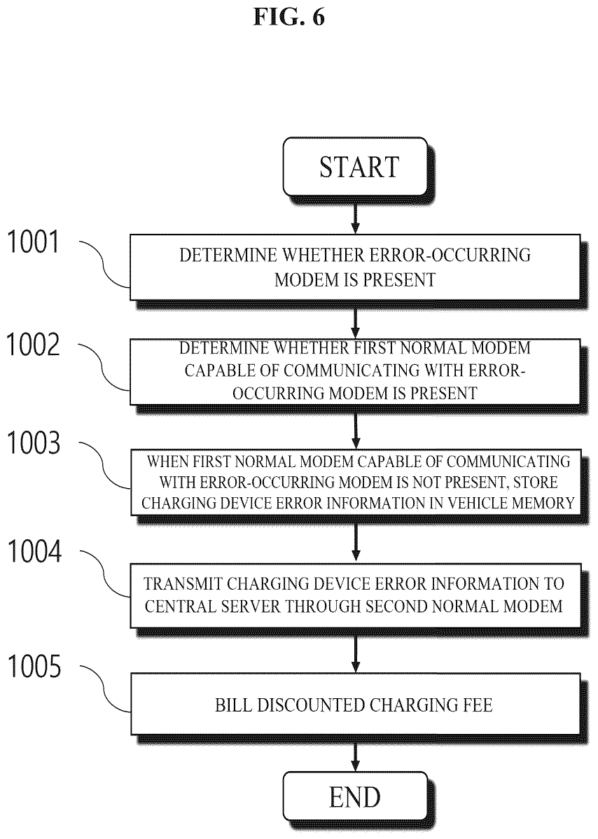

FIG. 6 is a flowchart of a method of controlling a network abnormality response system according to an embodiment. This is only a preferred embodiment for achieving the objective of the present disclosure, and it is clear that some components may be added or deleted as needed.

Referring to FIG. 6, the processor 100 may determine whether the modem 210 of at least one dispenser 200 is the error-occurring modem 213 of the error-occurring dispenser 202 in which a communication error has occurred between the modem 210 and the central server 400 (1001).

When error-occurring modem 213 is present, the processor 100 may determine whether the first normal modem 211 that is electrically connected to the error-occurring modem 213 in electric vehicle charging station 2 is present and whether communication between the error-occurring modem 213 and the first normal modem 211 in the electric vehicle charging station 2 is possible (1002).

When the first normal modem 211 capable of communicating with the error-occurring modem 213 is not present, the processor 100 may store the charging device error information including at least one of ID information, position information, and error type information regarding the error-occurring dispenser 202 in the vehicle memory 320 of the electric vehicle 300 connected to the error-occurring dispenser 202 (1003).

When the electric vehicle 300 is electrically connected to the normal dispenser 201, the processor 100 may control the second normal modem 212 to transmit the charging device error information stored in the vehicle memory 320 to the central server 400 (1004).

When the second normal modem 212 transmits the charging device error information stored in the vehicle memory 320 to the central server 400, the processor 100 may determine the discounted charging fee that is discounted relative to the standard charging fee corresponding to the charging process for the electric vehicle 300 connected to the normal dispenser 201. The processor 100 may control the normal dispenser 201 that charges the electric vehicle 300 to perform a billing process that bills the discounted charging fee to the electric vehicle 300 (1005).

The method of controlling the network abnormality response system 1 according to the embodiments of the present disclosure described above and those to be described later may be implemented in the form of a program executable by the processor 100.

The program may include program commands, data files, and data structures, either alone or in combination. The program may be designed and constructed using machine language codes or high-level language codes. The program may be specially designed to implement the method of controlling the network abnormality response system 1 described above, or may be implemented using various functions or definitions that are already known and available to those skilled in the field of computer software. The program for implementing the above-described method of controlling the network abnormality response system 1 may be recorded on a recording medium readable by the processor 100. In this case, the recording medium may be memory.

The memory may store a program that performs the operations described above and those to be described later, and the memory may execute the stored program. In cases where the processor 100 and the memory are provided in plural numbers, they may be integrated into a single chip or provided in physically separate locations. The memory may include volatile memory such as Static Random Access Memory (S-RAM) and Dynamic Random Access Memory (D-RAM) for temporarily storing data. In addition, the memory may include non-volatile memory such as Read Only Memory (ROM), Erasable Programmable Read Only Memory (EPROM), and Electrically Erasable Programmable Read Only Memory (EEPROM) for long-term storage of a control program and control data.

The processor 100 may include various logic circuits and arithmetic circuits, and may process data according to a program provided from the memory, and generate a control signal according to the processing result.

While the present disclosure has been described with reference to the illustrated embodiments, these are merely exemplary, and it will be understood by those skilled in the art that various alterations, variations, and equivalent other embodiments may be made without departing from the gist and scope of the present disclosure. Therefore, the scope of the present disclosure should be defined by the technical spirit of the appended claims.

What is claimed is:

1. A network abnormality response system comprising:
at least one modem included in each of a plurality of dispensers for charging an electric vehicle; and
a processor that controls the dispenser to perform communication through a bypass route when a communication error situation occurs between a modem of the dispenser and a central server,
wherein the processor is configured to:
determine whether the at least one modem of the dispenser is an error-occurring modem of an error-occurring dispenser in which a communication error has occurred between the modem and the central server; and
control a normal modem to transmit or receive information to be transmitted to or received from the central server by the error-occurring dispenser to or from the central server through the normal modem when the error-occurring modem is present, and
the normal modem is at least one of a modem included in a normal dispenser that is not the error-occurring dispenser and a vehicle modem included in an electric vehicle.

2. The network abnormality response system of claim 1, wherein the processor is configured to:
control at least one of a first normal modem and a second normal modem to transmit information to be transmitted to the central server by the error-occurring dispenser to the central server through at least one of the first normal modem and the second normal modem when the error-occurring modem is present,
wherein the first normal modem is at least one of a normal modem electrically connected to the error-occurring modem so as to enable wired communication therebetween and the vehicle modem electrically connected to the error-occurring dispenser and included in the electric vehicle, and
the second normal modem is a modem included in the electrically connected normal dispenser after the electric vehicle that is electrically connected to the error-occurring dispenser is electrically connected to the error-occurring dispenser.

3. The network abnormality response system of claim 2, wherein the modem provided for each dispenser included in one electric vehicle charging station is electrically connected to modems of other dispensers so as to enable wired communication therebetween, and
the processor is configured to control the first normal modem to transmit or receive the information to be transmitted to or received from the central server by the error-occurring dispenser to or from the central server through the first normal modem that is electrically connected to the error-occurring modem in the electric vehicle charging station when the error-occurring modem is present.

4. The network abnormality response system of claim 3, wherein the processor is configured to:
determine whether the first normal modem that is electrically connected to the error-occurring modem in the electric vehicle charging station is present when the error-occurring modem is present; and
control the second normal modem to transmit the information to be transmitted to the central server by the error-occurring dispenser to the central server through the second normal modem when all modems respectively provided in the dispensers included in the electric vehicle charging station in which the error-occurring dispenser is provided are the error-occurring modem.

5. The network abnormality response system of claim 3, wherein the processor is configured to:
determine whether communication between the error-occurring modem and the first normal modem is possible in the electric vehicle charging station when the error-occurring modem is present; and
control the second normal modem to transmit the information to be transmitted to the central server by the error-occurring dispenser to the central server through the second normal modem when a communication error has occurred between the error-occurring modem and the first normal modem.

6. The network abnormality response system of claim 2, wherein the processor is configured to:
store charging device error information including at least one of ID information, position information, and error type information of the error-occurring dispenser in a vehicle memory of the electric vehicle connected to the error-occurring dispenser; and
control the second normal modem so as to transmit the charging device error information stored in the vehicle memory to the central server when the electric vehicle is electrically connected to the normal dispenser.

7. The network abnormality response system of claim 6, wherein the processor is configured to:
control a display included in the error-occurring dispenser; and
control the display so as to display a repair-assistance request screen when the electric vehicle is electrically connected to the error-occurring dispenser,
wherein the repair-assistance request screen is a screen requesting a driver of the electric vehicle to contribute to transmitting the charging device error information to the central server by connecting the electric vehicle to another dispenser.

8. The network abnormality response system of claim 7, wherein the processor is configured to control the display so as to display a discounted-price proposal screen when the electric vehicle is electrically connected to the error-occurring dispenser, and
the discounted-price proposal screen is a screen proposing to the driver of the electric vehicle that when the driver connects the electric vehicle to another dispenser and thereby contributes in transmitting the charging device error information to the central server, a charging fee will be discounted relative to a standard charging fee.

9. The network abnormality response system of claim 7, wherein, when the second normal modem transmits the charging device error information stored in the vehicle memory to the central server, the processor is configured to:
determine a discounted charging fee that is discounted relative to a standard charging fee corresponding to a charging process of the electric vehicle connected to the normal dispenser; and
control the normal dispenser to perform a billing process that bills the discounted charging fee to the electric vehicle.

10. The network abnormality response system of claim 9, wherein, when the second normal modem transmits the charging device error information stored in the vehicle memory to the central server, the processor is configured to:
determine an information storage time that is a time taken from a time point at which the vehicle memory of the electric vehicle stored the charging device error information to a time point at which the second normal modem transmits the charging device error information stored in the vehicle memory to the central server; and
determine the discounted charging fee so that the longer the information storage time is, the less a discounted charging fee corresponding to the charging process is billed.

11. A method of controlling a network abnormality response system including at least one modem included in each of a plurality of dispensers for charging an electric vehicle and a processor, the method comprising:
performing, by the processor, communication through a bypass route when a communication error situation occurs between a modem of the dispenser and a central server,
wherein the performing of the communication through the bypass route includes:
determining, by the processor, whether at least one modem of the dispenser is an error-occurring modem of an error-occurring dispenser in which a communication error has occurred between the modem and the central server; and
controlling, by the processor, the normal modem to transmit or receive information to be transmitted to or received from the central server by the error-occurring dispenser to or from the central server through the normal modem when the error-occurring modem is present,
wherein the normal modem is at least one of a modem included in a normal dispenser that is not the error-occurring dispenser and a vehicle modem included in an electric vehicle.

12. The method of claim 11, wherein the controlling of the normal modem includes
controlling, by the processor, at least one of a first normal modem and a second normal modem to transmit the information to be transmitted to the central server by the error-occurring dispenser to the central server through at least one of the first normal modem and the second normal modem when the error-occurring modem is present,
wherein the first normal modem is at least one of a normal modem electrically connected to the error-occurring modem so as to enable wired communication therebetween and the vehicle modem electrically connected to the error-occurring dispenser and included in the electric vehicle, and
the second normal modem is a modem included in the electrically connected normal dispenser after the electric vehicle that is electrically connected to the error-occurring dispenser is electrically connected to the error-occurring dispenser.

13. The method of claim 12, wherein the modem provided for each dispenser included in one electric vehicle charging station is electrically connected to modems of other dispensers so as to enable wired communication therebetween, and
the controlling of the normal modem includes controlling, by the processor, the first normal modem to transmit or receive the information to be transmitted to or received from the central server by the error-occurring dispenser to or from the central server through the first normal modem that is electrically connected to the error-occurring modem in the electric vehicle charging station when the error-occurring modem is present.

14. The method of claim 13, wherein the controlling of the normal modem includes:
determining, by the processor, whether the first normal modem that is electrically connected to the error-occurring modem in the electric vehicle charging station is present when the error-occurring modem is present; and
controlling, by the processor, the second normal modem to transmit the information to be transmitted to the central server by the error-occurring dispenser to the central server through the second normal modem when all modems respectively provided in the dispensers included in the electric vehicle charging station in which the error-occurring dispenser is provided are the error-occurring modem.

15. The method of claim 13, wherein the controlling of the normal modem includes:
determining, by the processor, whether communication between the error-occurring modem and the first normal modem is possible in the electric vehicle charging station when the error-occurring modem is present; and
controlling, by the processor, the second normal modem to transmit the information to be transmitted to the central server by the error-occurring dispenser to the central server through the second normal modem when a communication error has occurred between the error-occurring modem and the first normal modem.

16. The method of claim 12, wherein the controlling of the normal modem includes:
storing, by the processor, charging device error information including at least one of ID information, position information and error type information of the error-occurring dispenser in a vehicle memory of the electric vehicle connected to the error-occurring dispenser; and
controlling, by the processor, the second normal modem so as to transmit the charging device error information stored in the vehicle memory to the central server when the electric vehicle is electrically connected to the normal dispenser.

17. The method of claim 16, further including controlling, by the processor, a display included in the error-occurring dispenser,
wherein the controlling of the display includes controlling, by the processor, the display so as to display a repair-assistance request screen when the electric vehicle is electrically connected to the error-occurring dispenser,
wherein the repair-assistance request screen is a screen requesting a driver of the electric vehicle to contribute to transmitting the charging device error information to the central server by connecting the electric vehicle to another dispenser.

18. The method of claim 17, wherein the controlling of the display includes controlling, by the processor, the display so as to display a discounted-price proposal screen when the electric vehicle is electrically connected to the error-occurring dispenser, and
the discounted-price proposal screen is a screen proposing to the driver of the electric vehicle that when the driver connects the electric vehicle to another dispenser and thereby contributes in transmitting the charging device error information to the central server, a charging fee will be discounted relative to a standard charging fee.

19. The method of claim 17, comprising: when the second normal modem transmits the charging device error information stored in the vehicle memory to the central server,
determining, by the processor, a discounted charging fee that is discounted relative to a standard charging fee corresponding to a charging process of the electric vehicle connected to the normal dispenser; and
controlling, by the processor, the normal dispenser to perform a billing process that bills the discounted charging fee to the electric vehicle,
wherein the determining the discounted charging fee includes:
determining, by the processor, an information storage time that is a time taken from a time point at which the vehicle memory of the electric vehicle stored the charging device error information to a time point at which the second normal modem transmits the charging device error information stored in the vehicle memory to the central server; and
determining, by the processor, the discounted charging fee so that the longer the information storage time is, the less a discounted charging fee corresponding to the charging process is billed.

20. A non-transitory computer readable recording medium storing computer program to execute the method of controlling the network abnormality response system of claim 1.
